(19) United States
(12) Patent Application Publication
(10) Pub. No.: US 2011/0130872 A1
(43) Pub. Date: Jun. 2, 2011

(54) SYSTEM AND METHOD FOR CREATING AN INTELLIGENT MAIL BARCODE

(75) Inventor: Harry T. WHITEHOUSE, Portolo Valley, CA (US)

(73) Assignee: PSI Systems, Inc., Palo Alto, CA (US)

(21) Appl. No.: 12/627,199

(22) Filed: Nov. 30, 2009

(51) Int. Cl. G06F 7/00; G06K 19/00

(52) U.S. Cl. 700/227; 235/487

(57) ABSTRACT

A system and method for creating an intelligent mail barcode artwork. The method includes inputting parameters including inputting a delivery point ZIP code; verifying the input parameters are within specified ranges; computing an intelligent mail barcode using the input parameters; and generating the intelligent mail barcode, the intelligent mail barcode containing and ascender bar, a descender bar, a tracker bar and a full bar.

### BACKGROUND OF THE INVENTION

1. Field of the Invention

The present invention pertains to postage indicia, and in particular to a method and system for creating an intelligent mail barcode, and a method for creating a mail artwork layout.

2. Discussion of Related Art

For nearly 20 years, the United States Postal Service (USPS) has employed a simple one dimensional barcode topology known as POSTNET barcode on letters, cards and flats to help route mail through the USPS automated mail processing systems. The POSTNET barcode simply represents the destination ZIP code for the mail piece. The destination ZIP code is normally 11 digits long and is comprised of the ZIP 5-digit code, a 4 digit add-on, and a 2-digit delivery point value. FIG. 1 shows a typical Business Reply Mail design using the older POSTNET barcode. The POSTNET barcode is shown below the destination address.

Creating a mail piece and associated artwork for the mail piece is relatively simple when using the POSTNET barcode. The delivery address can include the ZIP code verified over communications lines using an approach described in U.S. Pat. No. 5,341,505 to Whitehouse, the entire contents of which are incorporated herein by reference. For Business Reply Mail, the printing algorithms in the software simply construct the barcode with the 9 digits of the ZIP code. For courtesy replay mail pieces, the POSTNET is constructed of 11 digits. The last two digits are generally extracted from the street number. In the example shown in FIG. 1, the last two digits are “34” extracted from the street number “1234” in the street address “1234 Main Street.” The basic premise is that the POSTNET barcode is constructed entirely of elements from the destination address. In fact, the POSTNET bar code essentially represents the ZIP code information and nothing more.

Recently, the USPS introduced a new 4-state one-dimensional barcode known alternately as “OneCode” or the “Intelligent Mail® Barcode” (IMB). The IMB can carry more data while remaining approximately the same size (e.g., the same length) as the POSTNET code. The IMB contains, in addition to the destination ZIP code information, a mailer ID, a serial number, a barcode type, and a service code. The barcode not only identifies where the mail piece is going, but who sent it, what services might be requested, and provides an optional way to uniquely identify the location of specific mail pieces in the operational mail stream.

FIG. 2 illustrates an example of the same Business Reply Mail specimen shown in FIG. 1 but using the Intelligent Mail Barcode (IMB). The IMB is shown below the destination address. The IMB is a height-modulated barcode that encodes up to 31-digits of mailpiece data into 65 vertical bars using 4-state symbology (ascender, descender, tracker and full bar). A detailed description of the USPS IMB code can be found in a USPS publication entitled “Intelligent Mail Barcode Technical Resource Guide” Rev. 3.3, published on May 14, 2008, the entire contents of which is incorporated herein by reference. The contents of the barcode are much more diverse than that of the POSTNET as shown by Table 1.

TABLE 1

| Type | Filed | Field Length (in digits) |
|---|---|---|
| Tracking Code | Barcode Identifier | 2 (2^{nd} digit must be 0-4) |
| | Service Type Identifier | 3 |
| | Mailer Identifier | 6 or 9 |
| | Serial Number | 9 (when used with 6-digit |
| | | Mailer ID) |
| | | 6 (when used with 9-digit |
| | | Mailer ID |
| Routing Code | Delivery Point ZIP Code | 0, 5, 9, 0r 11 |

| | |
|---|---|
| Total Data Payload | 31 (maximum) |

The Barcode Identifier is a 2-digit field that is reserved to encode the presort identification that is currently printed in human readable form on the optional endorsement line (OEL) as well as for future Postal Service use. Generally, this field is left as “00” if an OEL is not printed on the mail piece. However, other digit pairs can also be used to indicate a carrier route, area distribution, or other indicators for mail sorting. The second digit in the Barcode Identifier must be 0 to 4.

The Service Type Identifier field is a 3-digit field that indicates participation in various Postal Service Programs, or the lack thereof. Each 3-digit identifier corresponds to a particular mail class with a particular combination of services. For example, the Service Type Identifier can identifies special services requested such as OneCode Confirm™ and/or OneCode ACS™ or Mail Class when used for automation rate discount without any services. For example, 700 is assigned to first-class mail, 702 is assigned to standard mail, 704 is assigned to periodicals, etc. . . . Mailers using Business Reply Mail (BRM) without any services can populate the Service Type Identifier field with the 3-digit code “708” to obtain a mail automation rate discount.

The Mailer Identifier (MID) field is a 6-digit or 9-digit number that identifies a mailer, a specific agent in the mail preparation process who has responsibility for the ownership, content, make up, or preparation of the mail. USPS Mailpiece Design Analysts (MDAs) are responsible for issuing Mailer IDs to customers. Mail owners and mail preparers are granted 6-digit or 9-digit Mailer IDs based upon their mail volume and criteria identified by the MDA. All 6-digit Mailer IDs begin with “0” through “8” and all 9-digit Mailer IDs will begin with “9”.

The Serial Number field is a 6-digit or 9-digit field depending on the length of the MID. The Serial Number can be populated with a number that uniquely identifies each mail piece, thus becoming a unique mail piece ID. Alternatively, the Serial Number may also be populated with a number that is unique to a group of envelopes, thus becoming a unique identifier of mail pieces associated with a certain advertizing or promotional campaign.

The Routing Code or Routing ZIP Code field is used to encode the destination or delivery point ZIP code of the mail piece. This field may contain a 5-digit ZIP code, a 9-digit Zip code, or an 11-digit delivery point code. When used on letters for automation-rate discount eligibility purposes, the routing code must contain a delivery point code that accurately matches the delivery address. When used on flat-size mail pieces for automation-rate discount eligibility purposes, the barcode must contain either the 5-digit ZIP code plus 4 additional digits (i.e., a 9-digit ZIP code) or a delivery point routing code that accurately matches the delivery address (i.e., a 11-digit ZIP code).

Remittance mail, such as Courtesy Reply Mail (CRM), Meter Reply Mail (MRM), and Permit Reply Mail (PRM) may use the Intelligent Mail Barcode (IMB) by populating the Service Type ID field with the First-Class Mail designation. Mailers using Business Reply Mail (BRM) without any services can populate the Service Type ID field with 708.

To facilitate the adoption of the Intelligent Mail barcode, the Postal Service has developed, and is making available at no charge, a web-based, interactive encoder-decoder tool, and an extensive library of encoding software and fonts suitable for encoding and printing the Intelligent Mail Barcode (IMB). The encoding software requires two arguments, a 20-digit tracking code (including the Barcode Identifier, the Service Type Identifier, the Mailer Identifier, and the Serial Number), and none, 5, 9 or 11-digit routing code. The encoder will return the status of the encoding function along with a 65-character string of the letters F, A, D, or T, representing a full bar, ascender, descender, or tracker, respectively. When the string is printed with the Intelligent Mail Barcode (IMB) font, the actual barcode artwork will be produced.

Although the encoder-decoder software tool of the USPS produces the Intelligent Mail barcode, the USPS encoder-decoder software tool has some limitations and is cumbersome. For example, the USPS encoder-decoder software is not easy to use and requires a manual input of two arguments, a 20-digit tracking code (see Table 1), and none, 5, 9 or 11-digit routing code. The resulting barcode is not easy to integrate with the rest of the mail piece design.

### BRIEF SUMMARY OF THE INVENTION

An aspect of the present invention is to provide a method for creating an intelligent mail barcode. The method includes inputting parameters including inputting a delivery point ZIP code; verifying whether the input parameters are within specified ranges; computing an intelligent mail barcode using the input parameters; and generating an intelligent mail barcode containing and an ascender bar, a descender bar, a tracker bar and a full bar.

Another aspect of the present invention is to provide a computer system for creating an intelligent mail barcode. The computer system includes a storage memory configured to store specified ranges for a plurality of parameters including a delivery point ZIP code; and a processor. The processor is configured to output a graphical user interface having fields for receiving input parameters including a delivery point ZIP code, to verify the input parameters are within the specified ranges, to compute an intelligent mail barcode using the input parameters, and to generate the intelligent mail barcode, the intelligent mail barcode containing and ascender bar, a descender bar, a tracker bar and a full bar.

Yet another aspect of the present invention is to provide a method for creating a mail artwork layout, the mail artwork layout including a destination address and an intelligent mail barcode. The method comprises inputting parameters including inputting a delivery point ZIP code; verifying whether the input parameters are within specified ranges; computing an intelligent mail barcode using the input parameters; and generating the intelligent mail barcode, the intelligent mail barcode containing and ascender bar, a descender bar, a tracker bar and a full bar. The method further comprises positioning the destination address and the intelligent mail barcode in the mail artwork layout. In one embodiment, the method further comprises printing the mail artwork layout.

Although the various steps of the method of creating an intelligent mail barcode are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 shows a typical Business Reply Mail design using the older POSTNET barcode;

FIG. 2 illustrates an example of the same Business Reply Mail specimen shown in FIG. 1 but using an Intelligent Mail Barcode (IMB);

FIG. 3 depicts a software application graphical user interface print window, according to an embodiment of the present invention;

FIG. 4 shows a window depicting a graphical user interface of Intelligent Mail Barcode generator, according to an embodiment of the present invention;

FIG. 5 depicts an example of a mail artwork layout showing an Intelligent Mail Barcode artwork in a Business Reply Mail context obtained using the parameters defined in FIG. 4;

FIG. 6 depicts a typical design window for a Courtesy Reply Mail, according to an embodiment of the present invention;

FIG. 7 shows a window depicting a graphical user interface of Intelligent Mail Barcode generator with parameters inserted in Courtesy Reply Mail, according to an embodiment of the present invention;

FIG. 8 depicts an example of an artwork showing the Intelligent Mail Barcode artwork in a CRM context obtained using the parameters defined in FIG. 7;

FIG. 9 depicts a computer system for creating the intelligent mail barcode artwork, according to an embodiment of the present invention; and

FIGS. 10A-10E show various error messages that are displayed in windows, according to an embodiment of the present invention.

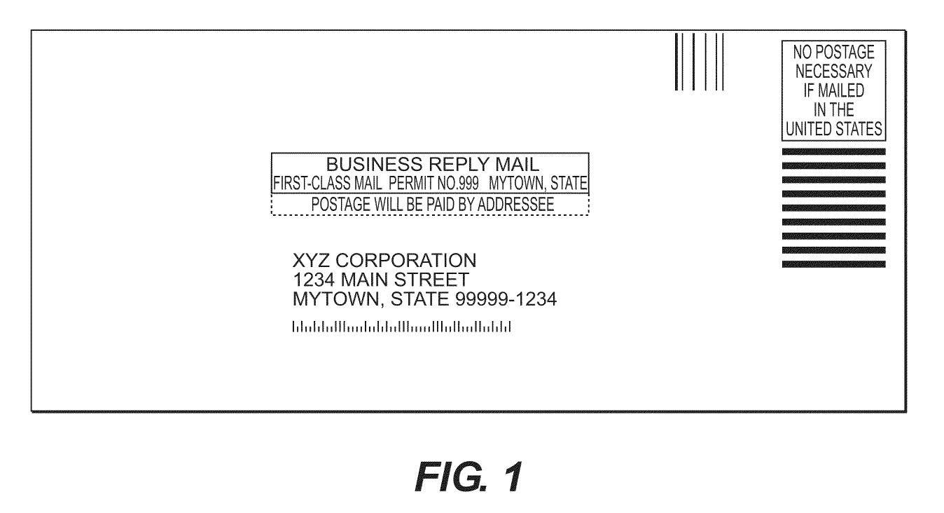

### DETAILED DESCRIPTION OF EMBODIMENTS OF THE INVENTION

According to an embodiment of the present invention, a method for creating a mail artwork layout including the Intelligent Mail Barcode (IMB) artwork is provided. The mail artwork layout can be used to create thousands or even millions of pre-addressed envelopes for business reply or courtesy reply functions. In one embodiment the method is implemented as a software application which when executed by a computer allows the creation of artwork on mail pieces for sending through the US Postal Service. The software application can be downloaded from an internet webpage. Alternatively, the software application can be obtained in a storage medium such as a CDROM, a USB flash memory or a PCMCIA memory card. The software application can be obtained free of charge or for a fee. Once the software application is installed in a personal computer of the user or mailer, the software application is ready to be used to print the artwork. By personal computer, it is meant that any computing device capable of running the software application can be used, such as, but not limited to, a desktop computer, a laptop computer, a handheld computing device, etc. Alternatively, the user does not need to install the software application on the personal computer. For example, the software application can be a web-based application and can be executed in a computer server.

In one embodiment, the software application allows designers to specify various parameters to construct the USPS Intelligent Mail Barcode artwork. For example, the software application can be used by mail piece designers to create a mail artwork layout for the mass production of business reply letters, cards and labels, courtesy reply envelopes, and international business reply letters, cards, and labels.

In one embodiment, the software application is configured to accept and validate the various parameters (e.g., a Barcode Identifier, a Service Type Identifier, a Mailer Identifier and a Serial Number) used in an Intelligent Mail Barcode (IMB) so that the appropriate IMB artwork may be printed.

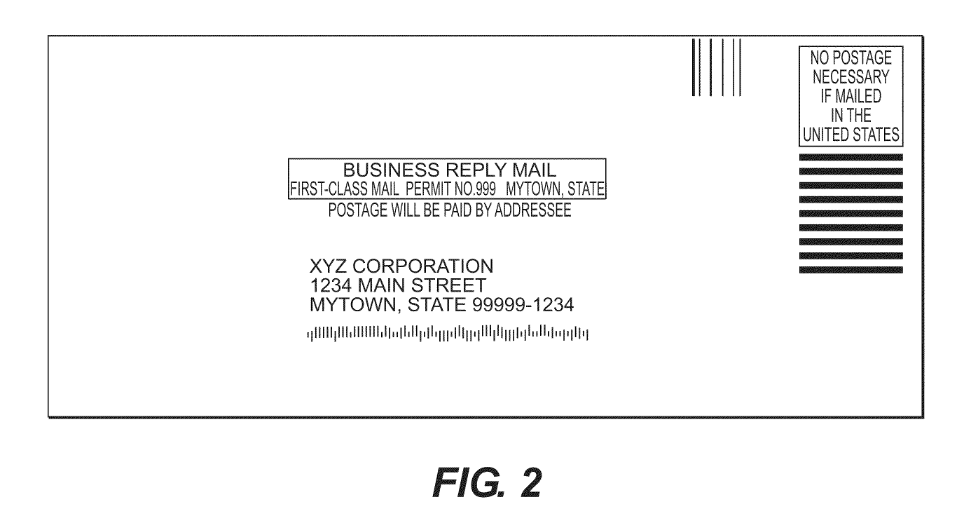

In one embodiment, the method is initiated when a print operation is initiated by the user. However, before initiating the print operation, the user can select in a design window how the mail piece design will look like. For example, the user can select in a design window the mail artwork layout, as shown in FIG. 2. In the design window depicted in FIG. 2, the user can move the destination address block and place the destination address block at any desired position within the mail artwork layout or “envelope.” The user can also change the font of the destination address and add logos on the envelope, add the “Business Reply Mail” information. The user can further move the barcode artwork at any position in the mail artwork layout independently from the destination address block. For example, the IMB artwork can be placed below the destination address block, as depicted in FIG. 2, above the destination address block, or placed at the lower right corner of the mail artwork layout.

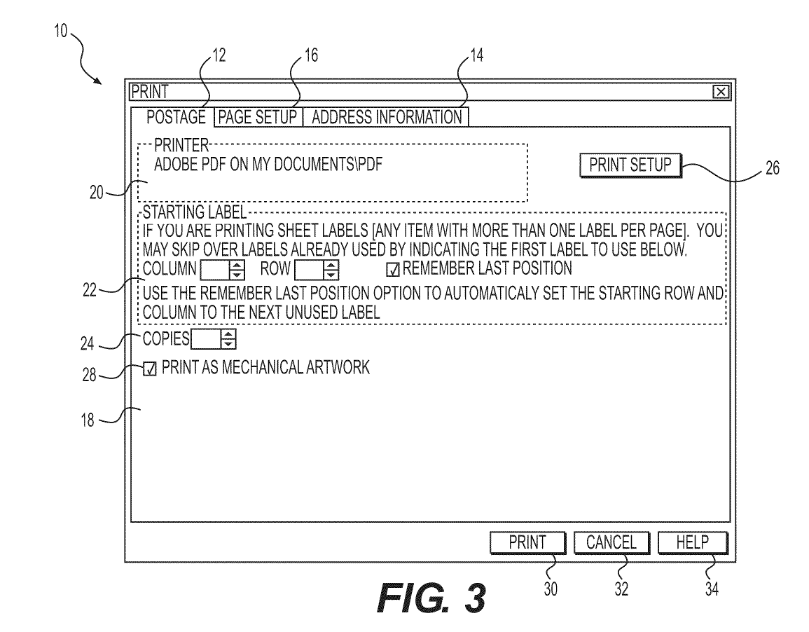

When the print operation is initiated, the software application opens a print window 10 on a graphical user interface of a computer associated with the user. FIG. 3 depicts the software application graphical user interface print window 10, according to an embodiment of the present invention. In one embodiment, the window 10 includes a tab 12 entitled “postage.” When a user clicks on tab 12, the user opens a window (not shown) for selecting various postage options. The window also includes a tab 14 entitled “address information.” When a user clicks on the tab 14, a window opens (not shown) allowing the user to input or verify the delivery or destination address information that will be printed on a mail piece. The Window 10 further includes tab 16 entitled “Page Setup.” When a user clicks on tab 16, a window 18 opens where the user can select various parameters such as printer type in sub-window 20, the type of desired label to be printed in sub-window 22, and number of copies in scroll-down menu 24. The user can also setup the printer used to print the intelligent mail barcode artwork by clicking on icon “Printer Setup” 26. The user can further specify whether or not the IMB artwork would be printed on the mail piece by checking a box “Print as Mechanical Artwork” 28. If the box 20 is checked by clicking on the box 20, the IMB artwork will be printed on the mail piece.

The window 10 also includes a print button 30, a cancel button 32 and a help button 34. The user can click on print button 30 to initiate the IMB artwork generator, click on button 32 to cancel the print procedure or click on button 34 to open a help window for guiding the user.

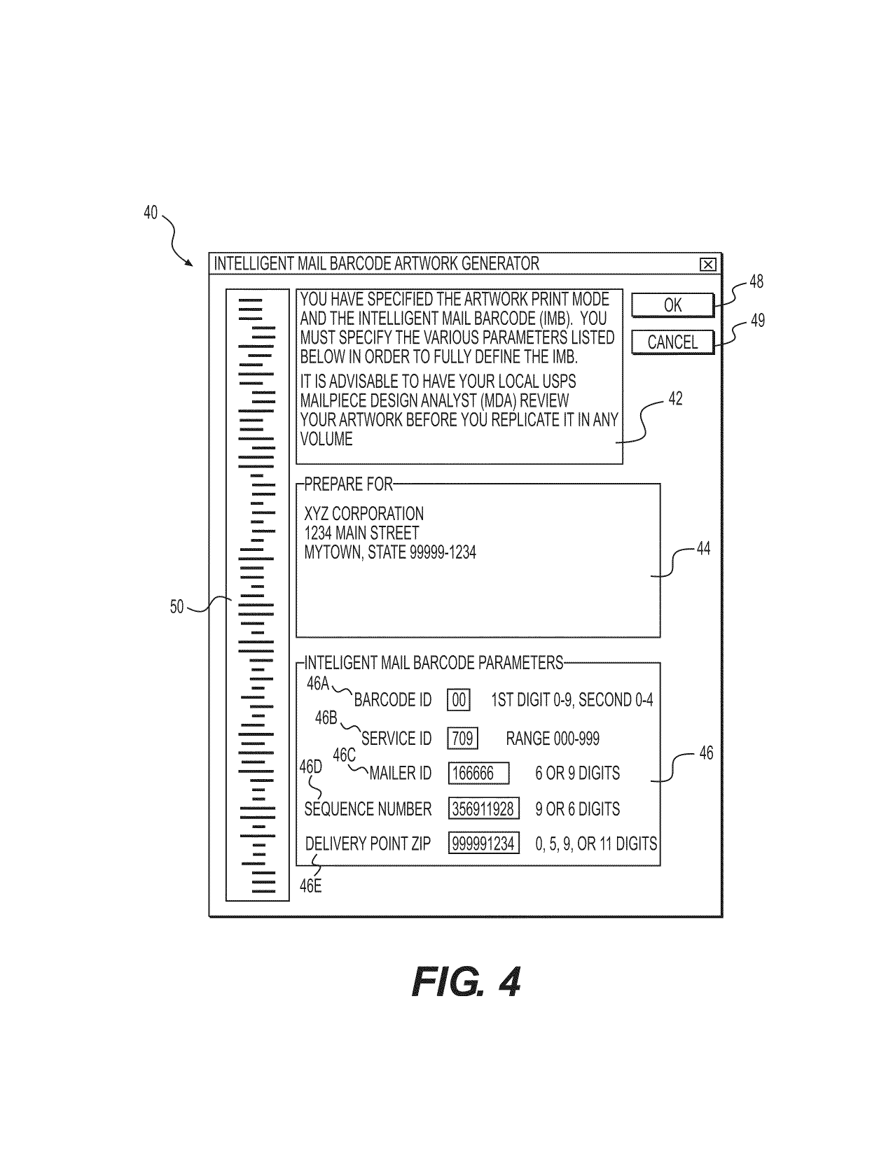

When the user clicks on button print 30, and the software application detects an Intelligent Mail Barcode is being used in the mail design and that the artwork option is checked, a window IMB generator 40 opens. FIG. 4 shows a window 40 depicting graphical user interface of IMB artwork generator, according to an embodiment of the present invention. In one embodiment, the window 40 includes 3 sub-regions. A sub-region 42 containing a text, such as “You have specified the artwork print mode and the intelligent mail barcode (IMB). You must specify the various parameters list below in order to fully define the IMB. It is advisable to have your local USPS mail piece Design Analyst (MDA) review your artwork before you replicate it in any volume.” A sub-region 44 containing the destination address that will be printed on the mail piece adjacent the artwork (e.g., XYZ Corporation, 1234 Main Street, Mytown, State 99999-1234). A sub-region 46 containing the various IMB parameters including Barcode ID 46A, Service ID 46B, Mailer ID 46C, Serial or Sequence Number 46D and delivery point ZIP code 46E. The user can input specific parameters into windows assigned or reserved to each of the parameters 46A, 46B, 46C, 46D and 46E.

For example, in the example depicted in FIG. 4, the user inputs 00 in Barcode ID 46A, 708 in Service ID 46B, 166666 in Mailer ID 46C, 356911928 in Serial or Sequence Number 46D and 999991234 in delivery point Zip code 46E. Inputting the sequence number is optional. However, in the case of Business Reply mail (BRM), the sequence number might be used to identify different mail-back campaigns. For instance, Campaign A which is polling for interest on the latest CAR might use sequence number 166666, whereas Campaign B polling for interest on the newest SUV might use a sequence number of 155555. Both campaigns might send out 250,000 BRM cards or letters and receive, for instance, 40,000 back for each campaign. The recipient, XYZ Corporation, could use the Intelligent Mail Barcode to sort responses between campaign A and B. The USPS would also be using the IMB to route the mail from the interested party back to XYZ Corporation and identify the originator of the mail piece (XYZ Corporation) for billing purposes or any anomalies encountered.

Using these various parameters 46A, 46B, 46C, 46D and 46E, the IMB artwork generator computes the IMB barcode, generates the artwork barcode 50 and displays the artwork barcode 50 in the window 40.

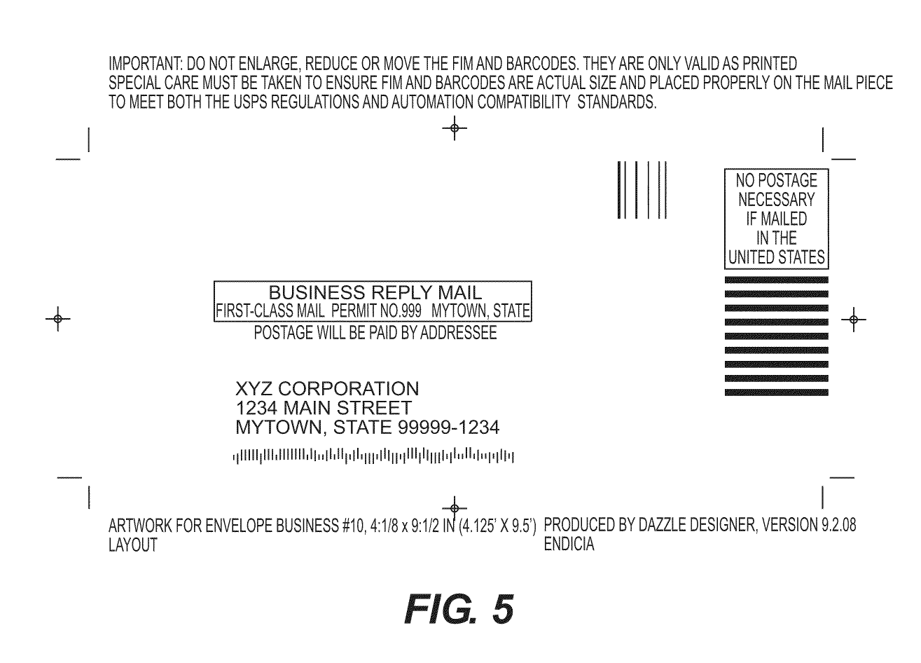

If the user is satisfied with the barcode artwork 50, the user can click on button “OK” 48 to print the barcode artwork. If not satisfied with the barcode artwork 50, the user can click on cancel button 49 to cancel the print procedure. FIG. 5 depicts an example of an artwork showing the Intelligent Mail Barcode artwork in a BRM context obtained using the parameters defined in FIG. 4.

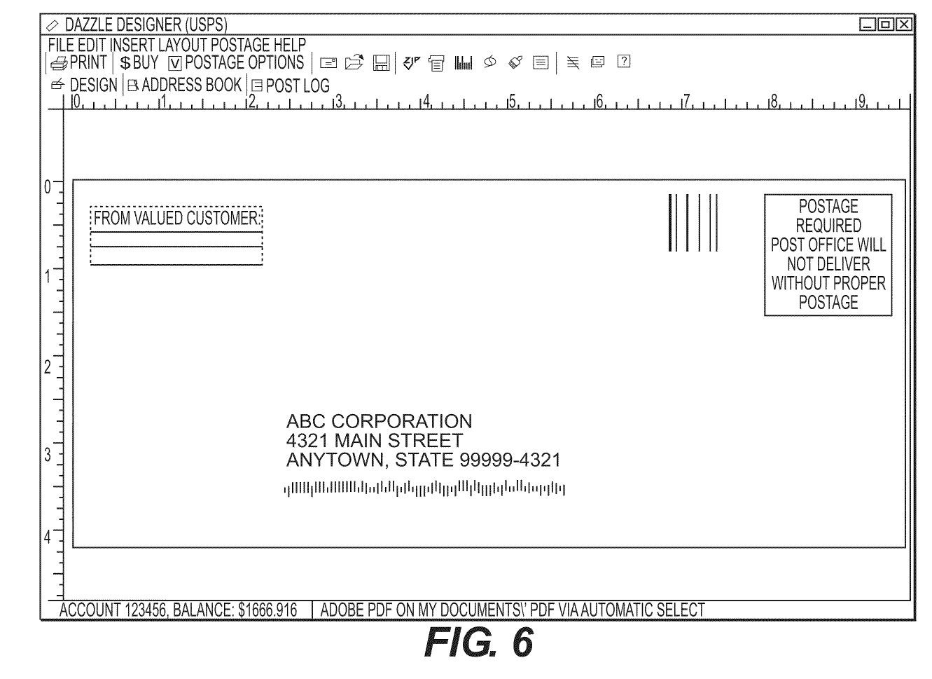

A courtesy reply mailpiece (CRM) follows the same design procedure, as illustrated in FIG. 6. FIG. 6 depicts a typical design window for a Courtesy Reply Mail, according to an embodiment of the present invention. FIG. 6 shows a CRM having printed thereon a destination address “ABC Corporation, 4321 Main Street, Anytown, State 99999-4321” along with the IMB printed below the destination address. Courtesy reply envelopes are often distributed by credit card companies, utilities, and banks to expedite the return of payments to those entities. They provide these envelopes so the returned payment is properly addressed and pre-barcoded with either a POSTNET or IMB barcode, both of which expedite mail routing. In the design window depicted in FIG. 6, the user can move the destination address block and place the destination address block at any desired position within the mail artwork layout or “envelope.” The user can also change the font of the destination address and add logos on the envelope, reserve a space on the mail artwork layout for the return address, etc. The user can further move the barcode artwork at any position in the mail artwork layout independently from the destination address block. For example, the IMB artwork can be placed below the destination address block, as depicted in FIG. 6, above the destination address block, or placed at the lower right corner of the mail artwork layout.

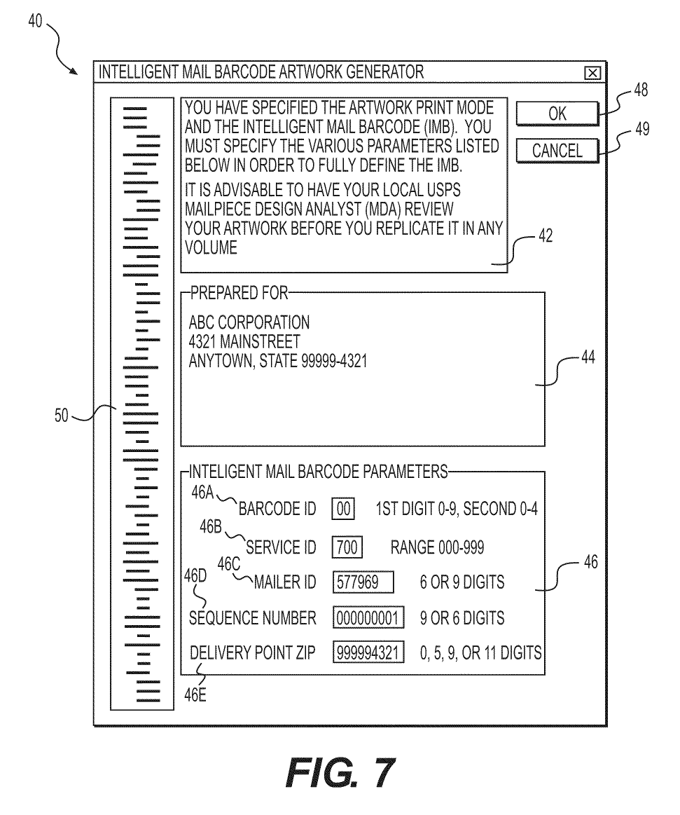

The various input parameters used in BRM are somewhat different in the case of CRM, as shown in FIG. 7. FIG. 7 shows a window depicting a graphical user interface of Intelligent Mail Barcode generator with parameters inserted in Courtesy Replay Mail, according to an embodiment of the present invention. For example, the service ID is always 700 and an 11-digit ZIP field is employed in CRM. On the other hand, in BRM the delivery point ZIP code contains only 9 digits and the service ID is 708.

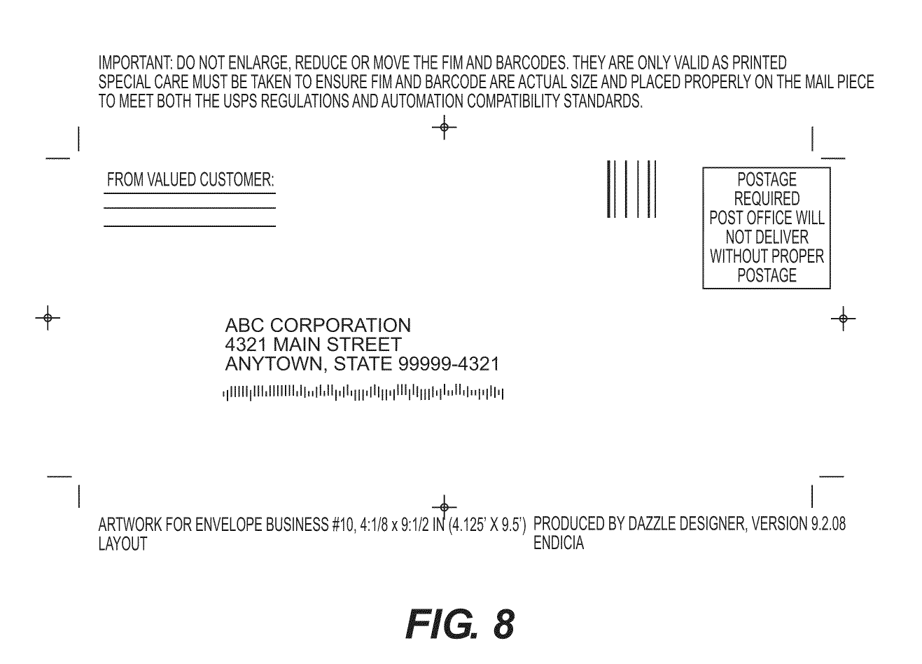

FIG. 8 depicts an example of an artwork showing the Intelligent Mail Barcode artwork in a CRM context obtained using the parameters defined in FIG. 7.

The present method and system for generating an IMB simplifies the process of creating mail piece artwork for a variety of mailing requirements. Aside from allowing the designer to specify all of the required parameters for an Intelligent Mail Barcode, the method and system provides a series of cross checks, i.e. verifies the various parameters, to ensure proper values within specified ranges (as discussed above) are input. For instance, when a Business Reply Mail (BRM) letter, card or label is being created, the program enforces the requirement for a Service ID of 708. In all case, the Service Type Identifier ID is checked to be certain that it contains 3 digits. For the Barcode ID, the software application checks to ensure that the second digit is between 0 and 4 (see Table 1) and that the entire ID is 2 digits long.

The Mailer ID can be 6 or 9 digits long, and the accompanying sequence or serial number must be 9 or 6 digits long accordingly. Put another way, the sum total of characters for the Mailer ID and Sequence number must be 15. The software program enforces this requirement as well as making sure that the Mailer ID and Sequence number are either 6 or 9 digits long.

The ZIP code information for Business Reply mail must be exactly 9 digits long and that rule is enforced by the software application. For other mail pieces such as Courtesy Reply mail, an 11 digit long barcode is required. All of these rules must be obeyed before a final print is allowed. In addition, in one embodiment, the software will generate an error message in the event the user inputs an incorrect digit or an incorrect number of digits. The error message, in one embodiment, would display a message indicating what the correct range or number of digits are, and/or that the input data is outside for that parameter. In another embodiment, the software will simply not allow the user to input digits that are outside of the correct range and/or of too many or too few digits by disabling input key strokes or preventing the cursor or input to advance to the next field.

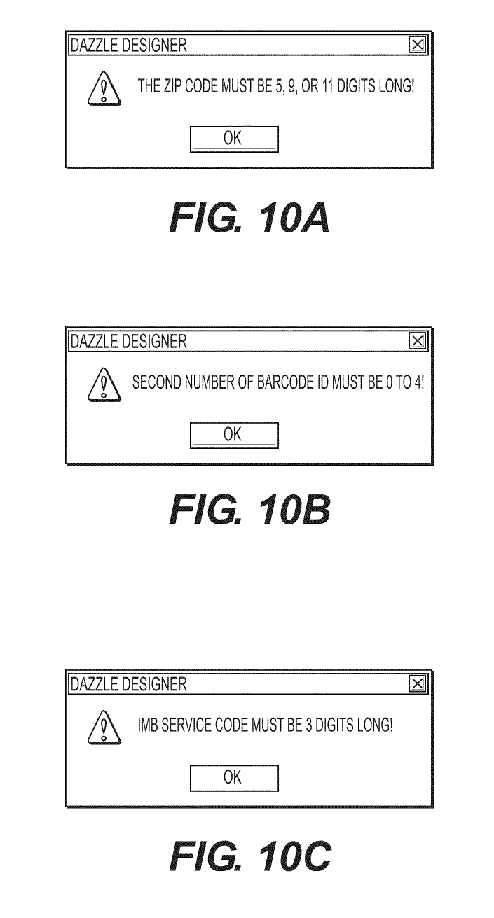

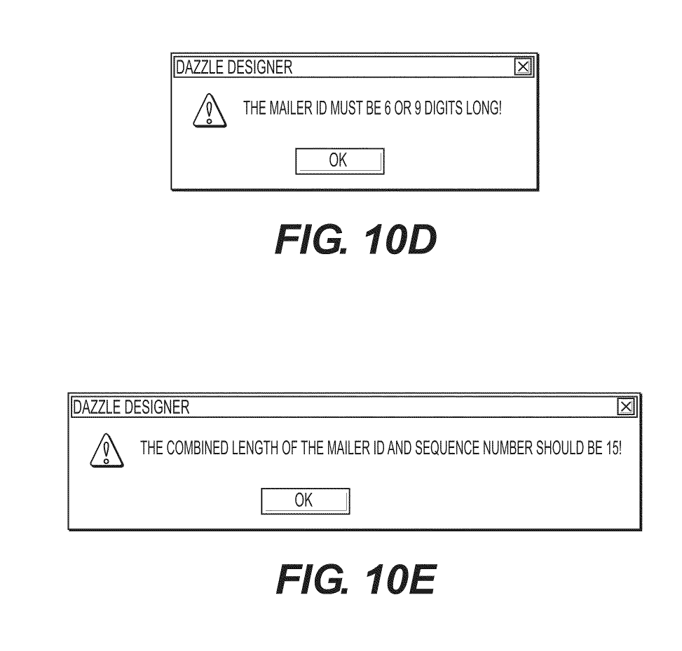

In one embodiment, when a user inputs a wrong number of digits (i.e., a number of digits different from 0, 5, 9 or 11) into the field reserved for Delivery Point Zip code 46E an error message is displayed in a graphical user interface window, shown in FIG. 10A, stating for example “The ZIP Code must be 5, 9 or 11 digits long!” If a user selects a Business Reply Mail and inputs a number of digits different from 9 into the field reserved for Delivery Point Zip code 46E, an error message is displayed in a graphical user interface window stating for example “The ZIP Code for Business Reply must only be 9 digits long!”

In one embodiment, when a user inputs a wrong number of digits (i.e., a number of digits different from 2) into the field reserved for barcode ID 46A, an error message is displayed in a graphical user interface window, stating for example “Barcode ID must be 2 digits long!” If the user inputs the correct number of 2 digits in the field reserved for the barcode ID 46A but inputs a second digit that is different from the range 0 to 4, a message is displayed in a graphical interface window, shown in FIG. 10B, stating “Second number of barcode ID must be 0 to 4!”

In one embodiment, when a user inputs a wrong number of digits (i.e., a number of digits different from 3) into the field reserved for Service ID 46B, an error message is displayed in a graphical user interface window, shown in FIG. 10C, stating for example “IMB Service Code must be 3 digits long!”

In one embodiment, when a user inputs a wrong number of digits (i.e., a number of digits different from 6 or 9) into the field reserved for Mailer ID 46C, an error message is displayed in a graphical user interface window, shown in FIG. 10D, stating for example “The Mailer ID must be 6 or 9 digits long!”

In one embodiment, when a user inputs a wrong number of digits (i.e., a number of digits different from 6 or 9) into the field reserved for Sequence or Serial Number 46D, an error message is displayed in a graphical user interface window stating for example “The Sequence number must be 6 or 9 digits long!”

The software application verifies whether the sum of the number digits in the Mailer ID 46C and the number of digits in the Sequence Number 46D is equal to 15. If the sum of the digits in the Mailer ID and the number of digits in the Sequence Number is different from 15, an error message is displayed in a graphical interface window, shown in FIG. 10E, stating for example “The combined length of the Mailer ID and Sequence Number should be 15!” In other words, the software application verifies whether the serial or sequence number has 9 digits when the mailer identifier has 6 digits and verifies that the serial number or sequence number has 6 digits when the mailer identifier has 9 digits.

Therefore, as it can be appreciated from the above paragraphs, in an embodiment of the present invention there is provided a computer readable medium (e.g., a software application), which when executed, creates an intelligent mail barcode. The computer readable medium enables inputting of parameters including inputting a delivery point ZIP code; verifying whether the input parameters are within a specified range; computing of an intelligent mail barcode using the input parameters; and generating the intelligent mail barcode, the intelligent mail barcode (i.e., intelligent mail barcode artwork) containing an ascender bar, a descender bar, a tracker bar and a full bar.

Also, as it can be appreciated from the above paragraphs, in one embodiment, the computer readable medium further generates an error message in the event that the input parameters are not within the specified range.

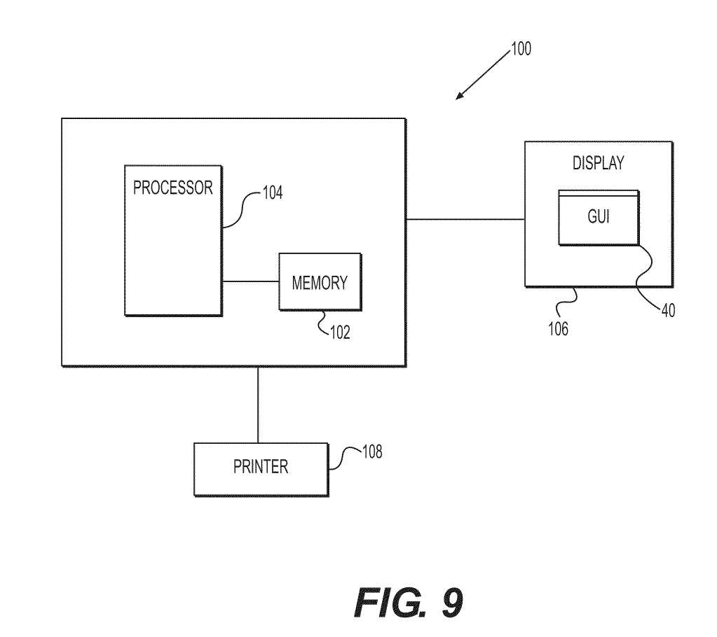

FIG. 9 depicts a computer system for creating the intelligent mail barcode artwork described above, according to an embodiment of the present invention. The computer system 100 comprises a storage memory 102, a processor 104 in communication with the memory 102 and optionally a display 106 and printer 108. The storage memory 102 is configured to store specified ranges for a plurality of parameters a delivery point ZIP code, a barcode identifier, a service type identifier, a mailer identifier, and a serial number, described in the above paragraphs. The processor 104 is configured to output a graphical user interface (GUI), for example via display 106. An example of a graphical user interface (GUI) is shown in FIGS. 4 and 7, as window 40. The graphical user interface has fields 46A, 46B, 46C, 46D and 46E for receiving input parameters such as Barcode ID, Service ID, Mailer ID, Sequence or Serial Number and Delivery Point ZIP code (as shown in FIG. 4). The processor 104 is also configured to verify the input parameters are within the specified ranges. The specified ranges are displayed in the graphical user interface (GUI) 40 next to the fields for receiving the input parameters. The processor is further configured to compute an intelligent mail barcode using the input parameters, and generate an intelligent mail barcode artwork containing and ascender bar, a descender bar, a tracker bar and a full bar, such as mail barcode artwork 50 shown in GUI window 40.

In one embodiment, the processor 104 is configured to generate an error message if an input parameter in the input parameters 46A, 46B, 46C, 46D and 46E is outside of a specified range for that input parameter. In another embodiment, the processor 104 is further configured to disable input key strokes or prevent a cursor to advance to a next field (for example to advance from field reserved to parameter 46A to field reserved to parameter 46B), if an input parameter in the input parameters is outside of a specified range for that input parameter.

The computer system 100 may also include a printer 108. The printer 108 is in communication with the processor 104. The processor 104 can send instructions to the printer 108 to print the intelligent mail barcode artwork 50. For example, the printer can print the intelligent mail barcode artwork 50 on a mail envelope.

Although the various steps of the method of generating an IMB are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A method for creating an intelligent mail barcode, comprising:
inputting parameters including inputting a delivery point ZIP code;
verifying whether the input parameters are within specified ranges;
computing an intelligent mail barcode using the input parameters; and
generating the intelligent mail barcode, the intelligent mail barcode containing and ascender bar, a descender bar, a tracker bar and a full bar.

2. The method according to claim 1, further comprising printing the intelligent mail barcode subsequent to verifying the input parameters.

3. The method according to claim 1, wherein inputting parameters further comprises inputting a barcode identifier, a service type identifier, a mailer identifier, and a serial number.

4. The method according to claim 3, further comprising selecting a mail type, wherein verifying whether the input parameters are within specified ranges comprises verifying whether the input parameters are within specified ranges for the selected mail type.

5. The method according to claim 4, wherein the selected mail type comprises any one of a business reply mail, a courtesy reply mail, a meter reply mail, a permit reply mail, a card and a label.

6. The method according to claim 4, wherein verifying whether the input parameters are within specified ranges comprises verifying whether the service type identifier has three digits.

7. The method according to claim 4, wherein verifying whether the input parameters are within specified ranges comprises verifying whether the barcode identifier has two digits and that a second digit in the barcode identifier is between 0 and 4.

8. The method according to claim 4, wherein verifying whether the input parameters are within specified ranges comprises verifying whether the mailer identifier has 6 digits or 9 digits.

9. The method according to claim 4, wherein verifying whether the input parameters are within specified ranges comprises verifying whether the serial number has 9 digits when the mailer identifier has 6 digits and verifying that the serial number has 6 digits when the mailer identifier has 9 digits.

10. The method according to claim 4, wherein verifying whether the input parameters are within specified ranges comprises verifying whether the delivery point ZIP code when using business reply mail has 9 digits.

11. The method according to claim 1, further comprising, subsequent to verifying whether the input parameters are within specified ranges, generating an error message if an input parameter in the input parameters is outside of a specified range for the input parameter.

12. The method according to claim 11, wherein generating the error message comprises displaying a correct range or number of digits for the input parameter, or displaying that the input parameter is outside of range, or both.

13. The method according to claim 1, further comprising, subsequent to verifying whether the input parameters are within specified ranges, disabling input key strokes or preventing a cursor to advance to a next field, if an input parameter in the input parameters is outside of a specified range.

14. A computer program product comprising a computer readable medium having instructions stored thereon when executed by a computer performs the method recited in claim 1.

15. The computer program product according to claim 14, wherein the computer readable medium comprises a graphical user interface that displays the specified ranges next to reserved fields for inputting the input parameters.

16. A computer system for creating an intelligent mail barcode, comprising:
a storage memory configured to store specified ranges for a plurality of parameters including a delivery point ZIP code; and
a processor configured to:
output a graphical user interface having fields for receiving input parameters including a delivery point ZIP code,
verify whether the input parameters are within the specified ranges,
compute an intelligent mail barcode using the input parameters, and
generate the intelligent mail barcode, the intelligent mail barcode containing and ascender bar, a descender bar, a tracker bar and a full bar.

17. The computer system according to claim 16, wherein the processor is further configured to generate an error message if an input parameter in the input parameters is outside of a specified range for the input parameter.

18. The computer system according to claim 16, wherein the processor is further configured to disable input key strokes or prevent a cursor to advance to a next field, if an input parameter in the input parameters is outside of a specified range for the input parameter.

19. The computer system according to claim 16, wherein the graphical user interface is configured to display the specified ranges next to the fields for receiving the input parameters.

20. The computer system according to claim 16, further comprising a printer in communication with the processor, wherein the processor is configured to send instructions to the printer to print the intelligent mail barcode.

21. A computer readable medium, which when executed, creates an intelligent mail barcode, the computer readable medium enabling:
inputting of parameters including inputting a delivery point ZIP code;
verifying whether the input parameters are within a specified range;
computing of an intelligent mail barcode using the input parameters; and
generating an intelligent mail barcode artwork containing and ascender bar, a descender bar, a tracker bar and a full bar.

22. The computer readable medium according to claim 21, which further generates an error message in the event that the input parameters are not within the specified range.

23. A method for creating a mail artwork layout, the mail artwork layout including a destination address and an intelligent mail barcode, the method comprising:
inputting parameters including inputting a delivery point ZIP code;
verifying whether the input parameters are within specified ranges;
computing an intelligent mail barcode using the input parameters;
generating the intelligent mail barcode, the intelligent mail barcode containing and ascender bar, a descender bar, a tracker bar and a full bar; and
positioning the destination address and the intelligent mail barcode in the mail artwork layout.

24. The method according to claim 23, further comprising printing the mail artwork layout.
